(19) United States
(12) Patent Application Publication
(10) Pub. No.: US 2006/0221936 A1
(43) Pub. Date: Oct. 5, 2006

(54) Timing recovery for modem transmission on IP networks

(76) Inventor: Michael David Rauchwerk, Holmdel, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/096,023

(22) Filed: Mar. 31, 2005

(51) Int. Cl. H04L 12/66; H04L 12/28; H04L 12/54; H04J 3/06

(52) U.S. Cl. 370/352; 370/401; 370/428; 370/516

(57) ABSTRACT

Retraining of modems communicating data signals as voice signals via gateways over a packet network, such as a VoIP network, that does not communicate the sample clock of the transmitter to the receiver is eliminated by monitoring the buffer level in a receiving gateway, and adjusting the local clock as a function thereof, so that the long term average of the rate of incoming samples to the buffer is equal to the long term average rate of the codec clock which is used to clock samples out of the receiver buffer. Advantageously, there is no need to communicate clock synchronization information between the transmit and receive gateways. Further advantageously, only one gateway on the connection requires the functionality of the instant invention to be implemented therein.

### TECHNICAL FIELD

This invention relates to Internet Protocol (IP) networks, and more particularly, to IP networks carrying data modem transmissions.

### BACKGROUND OF THE INVENTION

It is well known that telephonic voice communication, e.g., originated from telephones, such as conventional analog telephones providing what is known as plain old telephone service (POTS), can be carried over Internet Protocol (IP) networks using the well known voice over IP (VoIP) standard. To achieve this, a VoIP gateway converts received voice signals, typically received in analog form, to a digital representation and packages the digital voice representation into IP packets. As part of the packaging process, the samples of digital voice are buffered, at least until enough have been accumulated to form one VoIP packet. The IP packets are carried over the IP network to a remote VoIP gateway, which restores the ordering of received packets, extracts the digital representation of the voice from the IP packets, stores the received chunks of the digital representation of the voice, and typically converts the buffered digital representation back to analog format.

There is a clock used for controlling the timing in digitizing the analog voice signal, typically located in the transmitting VoIP gateway. Similarly, there is a clock used for controlling the timing in reconstructing the analog voice from the received digital samples, typically in the receiving VoIP gateway. Although they are designed to operate at substantially the same rates, these clocks are not locked. The discrepancy between the clocks may cause samples to accumulate in the receiver buffer, in the event that the clock in the receiver is slower than the clock in the transmitter. If so, eventually, samples need to be dropped to avoid buffer overflow. Likewise, in the event that the clock in the receiver is faster than the clock in the transmitter, eventually the buffer will underflow. If so, padding is added to the reconstructed voice signal. Such dropping or padding is typically not noticeable to a human being listening to the resulting reconstructed signal.

When information signals are converted to voice band signals using a modem, and the resulting voice band signals are transmitted over an IP network to a receiving modem, which then reconstructs the information signals therefrom, the discrepancy between the clocks and the resulting buffer overflow or underflow eventually causes a loss of synchronization which results in a need for the modems to retrain. When the information signals are originated from a facsimile machine, the need to do periodic retraining has a limited effect, because the most common facsimile protocols typically retrain fairly often anyway, and the time required for retraining is relatively short. However, when the information signals are data signals, e.g., originated from a computer, the requirement to periodically retrain becomes quite burdensome, because the common data protocols do not require periodic retraining, but instead prefer to remain in constant carrier mode. Also, should retraining be required, the process is relatively lengthy.

One prior art solution to this problem of requiring periodic retraining is to employ so-called “modem relay”. As in known in the art, modem relay involves demodulating at the gateway the transmit modem signal, which uses a clock locked to the transmiting modem's clock; extracting the data being transmitted; packing the data being transmitted into IP packets; transmitting the IP packets to the receiving gateway; extracting the data at the receiving gateway; and remodulating the data onto a new modem carrier, the clock of which is locked to the clock of the receiving modem. Disadvantageously, because of modem relay standards issues and interoperability issues, gateways capable of performing modem relay are not widely deployed. Further disadvantageously, modem relay functionality needs to be implemented at the gateway at each end of the connection.

Although this problem has been presented in terms of VoIP networks, which is presently likely to be the most common manifestation of the problem, it is noted that any packet network that is carrying data modem signals treated as voice and does not convey the timing of the sample clock to the receiver will likely suffer from this problem.

### SUMMARY OF THE INVENTION

I have recognized that the problem of requiring retraining of modems communicating data signals as voice signals over a packet network, such as a VoIP network, that does not communicate the sample clock of the transmitter to the receiver can be eliminated, in accordance with the principles of the invention, by monitoring the buffer level in the receiving gateway, and adjusting the local clock as a function thereof, so that the long term average of the rate of incoming samples to the buffer is equal to the long term average rate of the codec clock which is used to clock samples out of the receiver buffer. Advantageously, there is no need to communicate clock synchronization information between the transmit and receive gateways. Further advantageously, only one gateway on the connection requires the functionality of the instant invention to be implemented therein.

### BRIEF DESCRIPTION OF THE DRAWING

In the drawing:

FIG. 1 shows a prior art arrangement in which modem signals are carried using voice over Internet protocol (VoIP);

FIG. 2 shows an arrangement similar to that of FIG. 1, but which overcomes the problem of the prior art;

FIG. 3 shows an exemplary flowchart for operating a gateway, such as one of gateways FIG. 2, in accordance with the principles of the invention;

FIG. 4 shows another prior art arrangement, similar to that shown in FIG. 1, in which modem signals are carried using voice over Internet protocol (VoIP);

FIG. 5 shows an arrangement similar to that of FIG. 4 but in which the problem of the prior art is overcome; and

FIG. 6 shows an exemplary embodiment of second order phase locked loop of FIG. 2.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Note that as used herein channel quality includes effects from channel properties, such as multipath; interference from other sources, such as other radio sources of the same or other systems as well as cosmic sources; and noise, such as thermal noise within the receiver itself.

Unless otherwise explicitly specified herein, the drawings are not drawn to scale.

In the description, identically numbered components within different ones of the FIGs. refer to the same components.

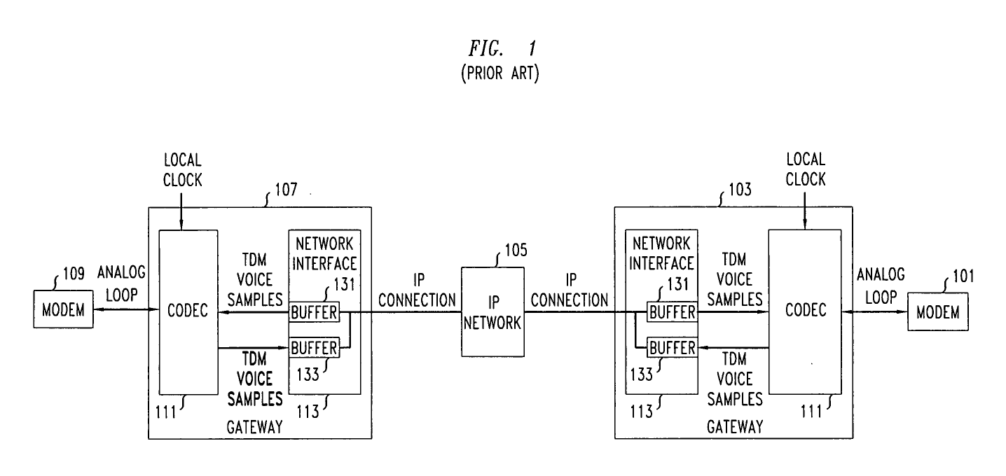

FIG. 1 shows a prior art arrangement in which modem signals are carried using voice over Internet protocol (VoIP). Shown in FIG. 1 are a) modem 101, b) gateway 103, Internet protocol (IP) network 105, c) gateway 107, and d) modem 109. Modems 101 and 109 are conventional modems. They may be either data modems or fax modems, although the problem described and solved herein tends to be more evident for data modems. IP network 105 is a conventional network for carrying IP packets. It may be a public or private network, or a combination thereof. Each of gateways 103 and 107 converts modem signals to VoIP packets and vice-versa. Each of gateways 103 and 107 is coupled to IP network 105 and also one of modems 101 and 109 in the manner shown.

Each of gateways 103 and 107 is made up of two parts, namely, codec 111 and network interface 113. Each codec 111 converts analog signals received from a modem to digital signals, such as those that are suitable to be carried by conventional time division multiplexed (TDM) communications equipment, e.g., at a sample rate of 8 kilohertz, which is controlled by a clock supplied to codec 111. Typically, although not necessarily, each sample is 8 bits. The resulting digital samples are supplied to the one of network interfaces 113 that is associated therewith by being part of the same gateway.

The associated network interface 113 stores the samples in buffer 133 until they are transmitted. Similarly, each codec 111 converts digital samples received from its associated network interface 113 into corresponding modem signals. Buffer 131 stores samples received from IP network 105 until they are supplied to the associated codec 111.

A problem arises with the arrangement of FIG. 1 when, for at least one of gateways 103 and 107, there is a locally generated clock that controls the sample rate of codec 111, and this clock is not locked to the clock controlling operation of IP network 105, i.e., the so-called “network clock”. Although they are designed to operate at substantially the same rates, since these local clocks are not locked to the network clock there tends to be a drift between each of the local clocks and the network clock. In the event the local clock of a gateway is slower than the local clock of the other gateway remote from it, receive buffer 131 tends to fill up, while receive buffer 131 tends to empty out when the local clock of a gateway is faster than the local clock the other gateway remote from it.

Note that since, typically, the connection between gateway 113 and IP network 105 is much faster than the sample rate, there is no problem of transmit buffer 133 filling up. Similarly, the IP connection between gateway 113 and IP network 105 can accept samples whenever they are available, so it is acceptable for buffer 133 to be empty without there being any concern about buffer underflow.

For voice applications, i.e., for a system where modems 101 and 109 are replaced by telephones, the problem with receive buffer 131 becoming over filled or empty can be easily handled by monitoring its fullness and either repeating prior samples when it runs toward empty, or dropping samples when a buffer becomes too full. In either case, the impact on voice quality tends to be minimal. Unfortunately, this solution is unsatisfactory for modem applications.

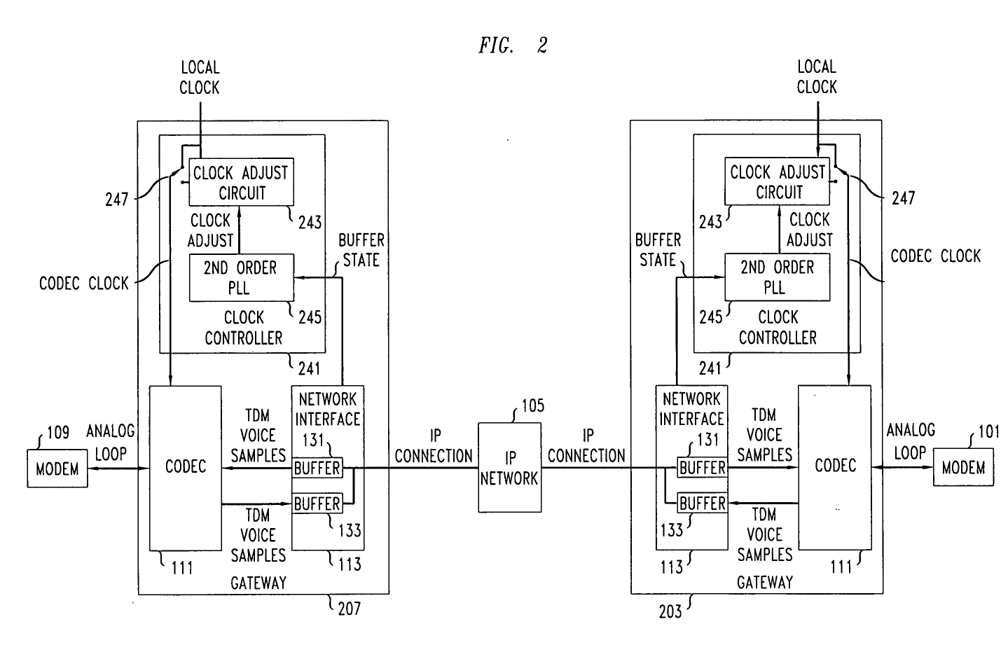

FIG. 2 shows an arrangement similar to that of FIG. 1, but which overcomes the problem of the prior art because gateways 103 and 107 of FIG. 1 have been replaced by gateways 203 and 207, respectively. Gateways 203 and 207 are arranged a) to monitor the fullness level of receive buffer 131 and b) to adjust the local clock as a function thereof, so that the long term average of the rate of incoming samples to receive buffer 131 from IP network 105 is equal to the long term average rate of the resulting adjusted clock that is used to clock samples out of receive buffer 131, in accordance with the principles of the invention.

To this end, each of gateways 203 and 209 now includes clock controller 241, which receives as an input a free running local clock, such as was supplied directly to codec 111 in FIG. 1, and also signal BUFFER_STATE, which indicates the fullness of receive buffer 131. More specifically, clock controller 241 includes 1) clock adjust circuit 243, which receives the free running local clock, and 2) second order phase lock loop (PLL) 245, which receives as an input signal BUFFER_STATE.

Generally, clock adjust circuit 243 is a conventional clock adjusting circuit which responds to a) a clock signal that is input thereto and b) supplied phase information to develop a modified version of the input clock which is supplied as an output. In the embodiment of the invention shown in FIG. 2, the local clock is the input clock that is supplied to, and adjusted by, clock adjust circuit 243 as a function of the phase information CLOCK_ADJUST that is supplied to clock adjust circuit 243. More specifically, in accordance with the principles of the invention, the local clock is adjusted by clock adjust circuit 243 so that the long term average rate of the modified version thereof, which is supplied via switch 247 as an output to codec 111 and is used thereby to clock samples out of buffer 131, is equal to the long term average of the rate of samples that are incoming to buffer 131. Advantageously, there is no need to communicate clock synchronization information between gateways 203 and 207.

Phase lock loop 245 takes as its input an error signal, which is signal BUFFER STATE, which represents the difference from half fullness of buffer 131. Phase lock loop 245 serves to filter the error signal and supplies as an output a clock adjust signal, which indicates the nature of the change in phase and frequency that is required to be performed by clock adjust 243 on the local clock so as to produce the codec clock. Note that the loop being monitored by phase locked loop 245 includes codec 1, which implicitly controls the fullness of buffer 131 in response to the codec clock supplied by clock adjust circuit 243.

In one embodiment of the invention, clock adjust circuit 243 may be implemented by a voltage controlled oscillator. In another embodiment of the invention, clock adjust circuit 243 may be implemented by a digitally controlled clock generator, which develops the output clock from an input clock that is running at a higher frequency than the desired output frequency by adding clock cycles to, or deleting clock cycles from, the input.

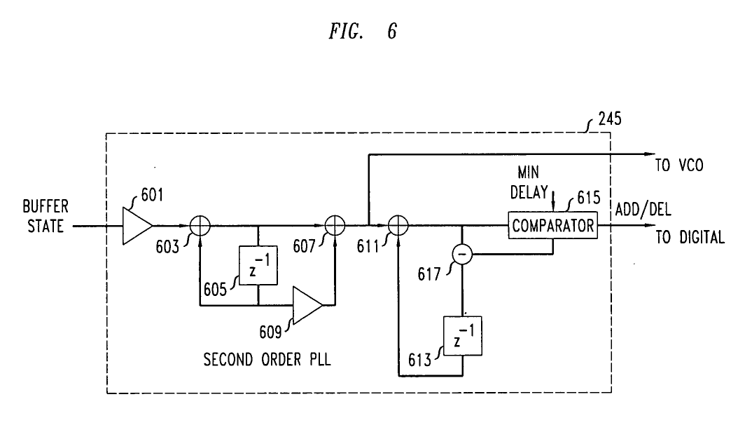

FIG. 6 shows an exemplary embodiment of second order phase locked loop 245. Shown in FIG. 6 are a) multipliers 601 and 609, b) adders 603 and 607, and optional adder 611, c) digital delay element 605 and optional digital delay element 613, d) optional comparator 615, and e) optional subtractor 617. Multiplier 601 receives a signal indicating the deviation of the current buffer fullness from the 50% buffer full point, e.g., the number of samples that the buffer has that is greater than, or less than, the point at which the buffer is 50% full. Multiplier 601 multiplies the deviation by a fixed factor to produce as an output a scaled deviation signal. Typically, the value of gamma is much less than 1, e.g., less than 0.1.

Digital delay elements are registers that provide as an output a delayed version of the value they receive as an input. The delay may be one sample delay, e.g., 125 microseconds for conventional voice samples operating at an 8 KHz clock rate. Adder 603 adds the scaled deviation signal to the output of delay element 605. The resulting value is supplied as an input to delay element 605 and to adder 607. The value stored in delay element 605 is indicative of how much of a sample period the local clock differs from the desired clock, in other words, the offset per sample period between the two clocks. The output of delay element 605 is also supplied to multiplier 609, which multiplies the output of delay element 605 by a factor ρ to produce a scaled version of the output of delay element 605. A typical value for ρ is −0.95.

The values of λ and ρ are selected so as to allow the loop to adapt quickly yet smoothly to changes in the buffer fullness deviation. Those of ordinary skill will readily be able to determine values for λ and ρ using conventional techniques for simulating the clock recovery loop. Adder 607 adds the output adder 603 and multiplier 609 and supplies the resulting sum as an input to adder 611.

The output of adder 607 represents the frequency offset of the local clock and the transmit clock, but scaled differently than the output of delay element 605. This output of adder 607 could be used to control a voltage controlled oscillator (VCO) directly, e.g., through a digital to analog (D/A) converter. In a steady operating state, where the adjust clock of the gateway matches the clock of the modem on the other side of the connection, the output of adder 607 should be a constant, and the buffer deviation signal should be zero.

Adder 611 adds the output of adder 607 to a delayed, and possibly adjusted, version of its own output, which is supplied both to digital delay element 613 and to comparator 615. The output of adder 611 represents the cumulative offset of the local clock and the desired clock, i.e., the clock in the gateway on the other side of the connection. The delay provided by digital delay element 613 may be one sample delay, e.g., 125 microseconds for conventional voice samples operating at an 8 KHz clock rate.

The output of adder 611 may be employed to control a digitally controlled clock generator. However, because a digital controlled clock generator can only adjust its clock in discrete intervals, the clock is not adjusted until the cumulative error reaches the level of one discrete adjustment of the digitally controlled clock. This is determined by comparator 615, which compares the output of adder 611 against a supplied value representing the discrete interval by which the clock may be adjusted. When the cumulative error reaches the level of one discrete adjustment of the digital controlled clock, comparator 615 supplies an output to cause the digital controlled clock to be adjusted as the output of phase locked loop 245. Furthermore, at that time, comparator 615 supplies to subtractor 617 the value of one discrete adjustment of the digital controlled clock. This value is subtracted from the value supplied as an output by adder 611, and the resulting adjusted value is stored in delay element 613. When no adjustment is needed, comparator 615 supplies a zero value to subtractor 617.

Returning to FIG. 2, the modified version of the local clock developed by clock adjust circuit 243 is supplied as the output of clock controller 241. In accordance with an aspect of the invention, the modified clock may be supplied as the sample clock to codec 111, e.g., via switch 247. Note that in the prior art, e.g., as shown in FIG. 1, the local clock was supplied directly to codec 111 as the sample clock. Further note that the modified clock may be different in both frequency and phase from the local clock as it was supplied to clock controller 241.

Note that although gateways 203 and 207 are shown as having the same structure, to accrue the benefits of the invention, only one of the gateways employed in a modem-to-modem connection should adjust its buffer in accordance with the principles of the invention. The other modem should not adjust its buffer, even if it has the ability to do so. In fact, should both gateways adjust their buffers in accordance with the principles of the invention, system operation may become unstable, as each gateway is trying to adjust to the other gateway's clock, which can create a feedback loop that may oscillate. This may be avoided, in accordance with an aspect of the invention, by having clock controller 241 of any gateway initially not adjust its buffer, e.g., by having switch 247 connect codec 111 to the local clock and to instead measure the relative speed of its own local clock with respect to the other gateway's local clock by monitoring its input buffer level.

More specifically, initially, no samples are clocked out of any buffer until that buffer reaches a 50% fullness level. Upon achieving 50% fullness, the process of clocking samples out of the buffer is started. The gateway with the slower clock will have its buffer continue to fill up beyond the 50% fullness mark, while the gateway with the faster clock will have its buffer begin to empty. By monitoring the change in buffer fullness, each gateway can determine whether it is the faster of the two gateways or the slower.

A convention may be established for gateways such that only the gateway with the relatively slower clock will adjust its clock in accordance with the principles of the invention, e.g., by changing the position of switch 247 to connect to the output of clock adjust circuit 243. The other gateway will continue with clock adjustment disabled, should it be capable of adjusting its clock, or will not have the ability to adjust its clock implemented. Thereafter, each gateway arranged in accordance with the principles of the invention continues to monitor its buffer. If a gateway arranged in accordance with the invention but which determined that its buffer was the faster buffer, and hence it did not enable clock adjustment, notices that its buffer has become close to empty, which can occur if the other gateway does not incorporate the invention, then the gateway incorporating the invention that has a buffer that is close to empty will enable operation of its clock adjust circuit in accordance with the principles of the invention, e.g., by changing the position of switch 247 to connect to the output of clock adjust circuit 243. This ensures that clock adjusting will not be performed in the gateways on both sides of a connection, and thus operation will be stable.

Those of ordinary skill in the art will readily be able to adapt the forgoing to the convention that the buffer of the gateway to implement the adjusting process is emptying before the adjusting is enabled.

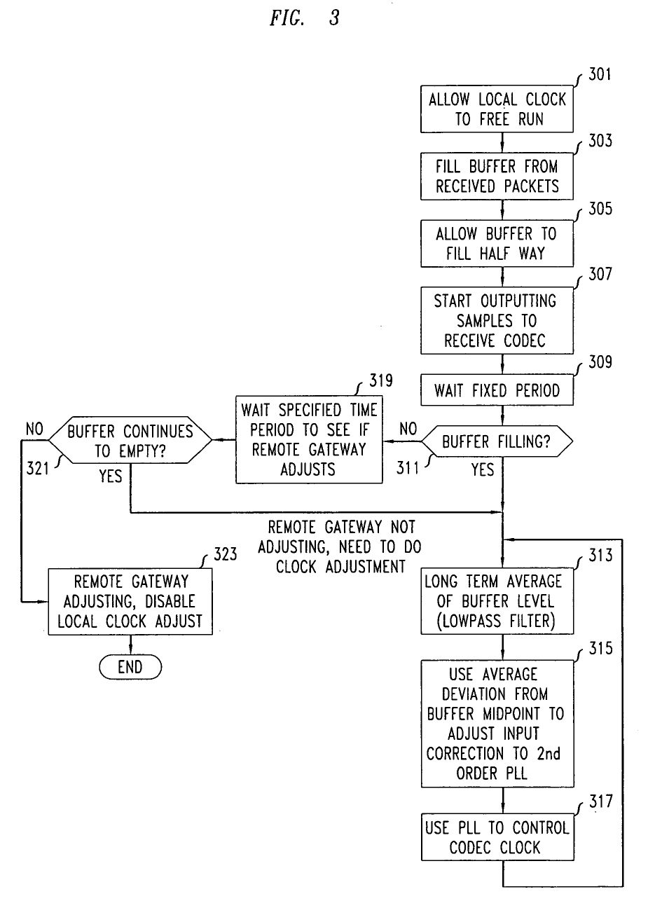

FIG. 3 shows an exemplary flowchart for operating a gateway, such as one of gateways 203 (FIG. 2) and 207, in accordance with the principles of the invention. The process is entered by starting the local clock upon activation of the gateway connection for communication via a modem, e.g., one of modems or 109. While the local clock is running freely, the buffer receiving packets from the IP network in the network interface, e.g., buffer 131, begins to fill with incoming packets in step 303 (FIG. 3), until it is determined in step 305 that the buffer is halfway filled.

In step 307, the process of outputting samples from the buffer to the codec is begun using the local clock without any adjustments. Step 309 allows a fixed period to pass, during which samples continue to be output from the buffer to the codec using the local clock without any adjustments. After waiting the prescribed period, conditional branch point 311 tests to determine if the buffer is now filled more than its 50% fullness level. If the test result in step 311 is YES, indicating that the buffer has been filling up during the waiting period, and further indicating that the unmodified local clock is slower than the clock of the modem at the other end of the connection, control passes to optional step 313, in which the long-term average of the buffer level is determined, e.g., using a lowpass filter. Such a lowpass filtering function may be performed by phase locked loop 245 (FIG. 2). In step 315 (FIG. 3), the average deviation of actual buffer fullness from the buffer halfway level is employed to adjust the input correction of a second order phase locked loop. The output of the phase locked loop is used to adjust the local clock and thereby develop the adjusted clock that is supplied to the codec for use in clocking samples out of the buffer in step 317. Control then passes back to step 313, and the process continues as described above.

If the test result in step 311 is NO, indicating that the buffer has been emptying during the waiting period, and further indicating that the unmodified local clock is faster than the clock of the modem at the other end of the connection, control passes to step 319, in which a further period is waited. This further period is waited in order to give the gateway on the other side of the connection time to adjust its clock if it is going to do so in accordance with the invention, since the gateway on the other side of the connection has the slower clock.

Conditional branch point 321 tests to determine if the buffer has continued to empty from the level it was at in step 311. If the test result in step 311 is NO, indicating that the buffer is no less empty, and may indeed be fuller, than its level in step 311, and thus further indicating that the other gateway has begun adjusting its clock, control passes to step 323, in which adjusting of the clock is disabled. The process then exits in step 325. If the test result in step 321 is YES, indicating that the buffer has become even emptier in that its level has reduced even further than the level it had in step 311, control passes to step 313 to begin clock adjusting, and the process proceeds as described above.

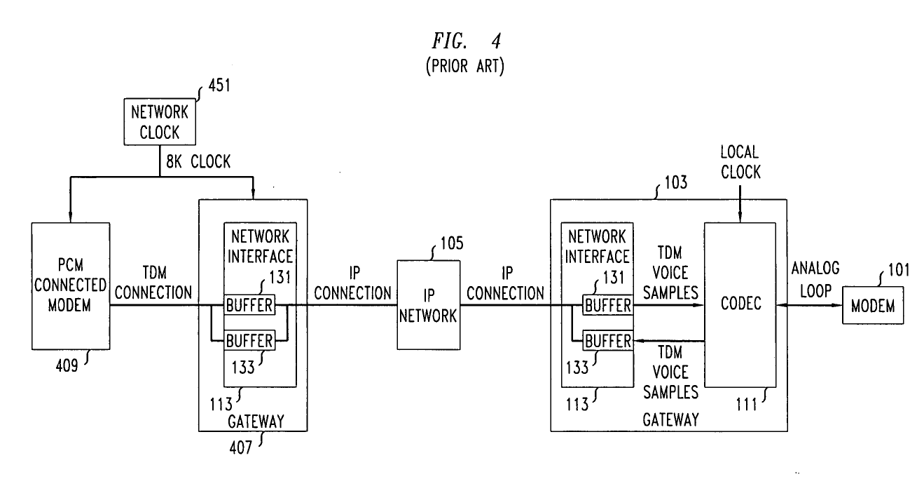

FIG. 4 shows another prior art arrangement, similar to that shown in FIG. 1, in which modem signals are carried using voice over Internet protocol (VoIP). However, rather than both ends of the connection being a conventional consumer modem, the end of the connection served in FIG. 1 by modem 109 is served in FIG. 4 by pulse code modulation (PCM) connected modem 409, is also know as a digitally connected modem.

A PCM connected modem receives the signal that a conventional modem would receive, but already in digitized, e.g., PCM format, i.e., the 64 kilobit digital format such as is carried in a DS0, which may be μ-law or A-law encoded. PCM connected modems are often employed by dial-up internet service providers which receive their incoming traffic directly as a digital stream, e.g., on a T1 line. Elimination of the codec in the modem and use of the analog signal in a PCM modem provides for less errors in the communication and reduced cost for the equipment.

Gateway 407 is a simplified version of gateway 107 (FIG. 1), in that, unlike gateway 107 gateway 407 (FIG. 4) does not require codec 111. Instead, the digital samples are transferred directly between buffers 131 and 133 and PCM connected modem 409 over the TDM connection between gateway 407 and PCM connected modem 409.

Note that unlike gateway 107 in FIG. 1, which is supplied with an independent local clock, gateway 407 is FIG. 4 is supplied with the network clock, which is represented symbolically in FIG. 4 by clock generator 451. This network clock is also supplied to PCM connected modem 409. Unfortunately, the sample clock supplied by clock generator 451 is not locked in synchronization with the local clock that is supplied as an input to gateway 103. As a result, the arrangement of FIG. 4 suffers from the same problem as does the arrangement of FIG. 1. Furthermore, the arrangement of FIG. 4 is likely to be the more common implementation in which the problem is manifest, because of its popularity with dial-up internet service providers.

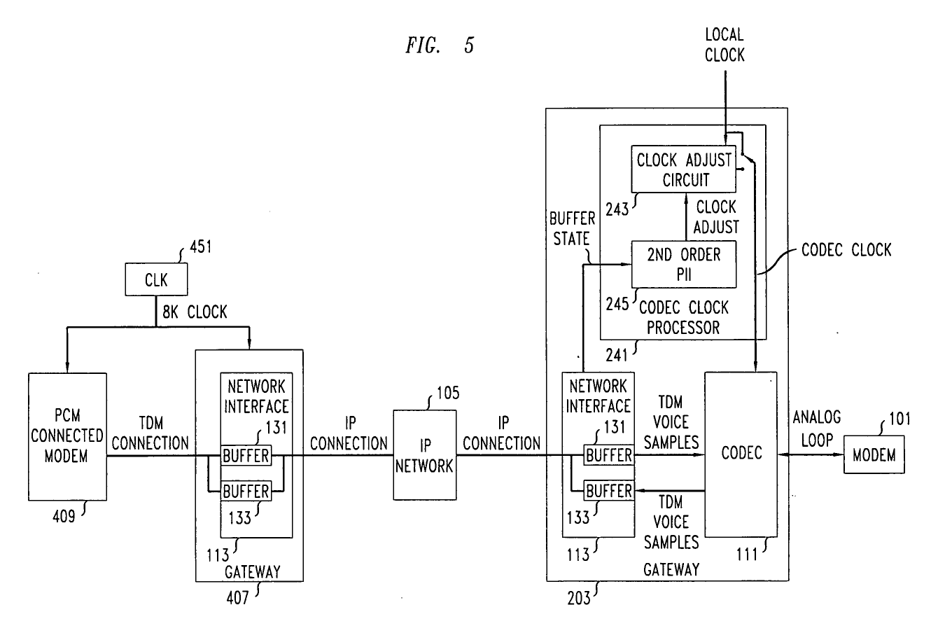

FIG. 5 shows an arrangement similar to that of FIG. 4 but in which the problem of the prior art is overcome because gateway 103 of FIG. 1 has been replaced by gateway 203. As described hereinabove in connection with FIG. 2, gateway 203 is arranged in accordance with the principles of the invention, to monitor the fullness level of receive buffer 131 and to adjust the local clock as a function thereof, so that the long term average of the rate of incoming samples to buffer 131 from IP network 105 is equal to the long term average rate of the codec clock which is used to clock samples out of receive buffer 131

What is claimed is:

1. A method for use in a gateway for a network in which information about sample timing is not transmitted across said network to said gateway, said gateway employing a buffer for temporarily storing received voice band samples that were generated by a modem to represent data signals and, said gateway also including a clock that indicates when a sample should be extracted from said buffer for subsequent processing of the analog information represented thereby, the method comprising the steps of:
measuring a fullness level of said buffer; and
adjusting said clock, as a function of said buffer fullness level, so that a long term average of the rate at which said received voice band samples are supplied to said buffer from said network is equal to a long term average of said frequency of said clock.

2. The invention as defined in claim 1 wherein said network is a voice over internet protocol (VoIP) and said gateway is a VoIP gateway.

3. The invention as defined in claim 1 wherein said adjusting step adjusts a phase of said clock.

4. The invention as defined in claim 1 wherein said adjusting step adjusts a frequency of said clock.

5. The invention as defined in claim 1 wherein said adjusting step is performed by a phase lock loop that is responsive to said buffer fullness level.

6. The invention as defined in claim 1 wherein said buffer fullness level is an indication of the fullness of said buffer with respect to a midpoint of fullness of said buffer.

7. Apparatus for use in a gateway coupled to a network in which information about sample timing is not transmitted across said network to said gateway, said gateway employing a buffer for temporarily storing received voice band samples that were generated by a modem to represent data signals and, said buffer being responsive to a clock that indicates when a sample should be extracted from said buffer for subsequent processing of the analog information represented thereby, the apparatus comprising:
a phase locked loop that supplies as an output a clock adjustment signal as a function of an indication of a fullness level of said buffer; and
a clock adjusting circuit, responsive to said clock adjustment signal, for supplying an adjusted version of an initial clock, said adjusted version being supplied to said buffer to indicate when a sample should be extracted from said buffer so that a long term average of the rate at which said received voice band samples are supplied to said buffer from said network is equal to a long term average of said frequency of said adjusted version of said clock.

8. The invention as defined in claim 7 wherein said network is a voice over internet protocol (VoIP) and said gateway is a VoIP gateway.

9. The invention as defined in claim 7 wherein said clock adjusting circuit adjusts said clock in discrete adjustment steps.

10. The invention as defined in claim 9 wherein said phase locked loop accumulates differences between said long term average of the rate at which said received voice band samples are supplied to said buffer from said network and said long term average of said frequency of said adjusted version of said clock and only sets said clock adjustment signal to indicate a clock adjustment is required when said long term average of said frequency of said adjusted version of said clock differs from said long term average of the rate at which said received voice band samples are supplied to said buffer from said network by a prescribed amount.

11. The invention as defined in claim 10 wherein said prescribed amount is the minimum adjustment that can be made by said clock adjusting circuit.

12. A method for use in a gateway providing conversion of a packet stream received from a network from which sample timing information is not conveyed to said gateway, to an analog voice band representation of the information contained in said packet stream, the method comprising the steps of:
receiving packets of said packet stream;
storing samples extracted from said packets in a buffer; and
extracting samples from said buffer for conversion to said analog voice band representation at a rate that is adjusted to have a long term average that is equal to the long term average rate at which said samples are stored in said buffer.

13. The invention as defined in claim 12 wherein said analog voice band representation is a modem signal.

14. The invention as defined in claim 12 wherein said network is a voice over internet protocol (VoIP) and said gateway is a VoIP gateway.

15. A gateway for coupling a circuit switched connection carrying data using an analog voice band representation and a packet carrying network across which sample timing is not transmitted to said gateway, comprising:
a buffer for storing samples of said voice band representation received from said packet carrying network;
a codec for converting samples supplied from said buffer to said analog representation;
wherein said samples are obtained by said codec from said buffer at a rate such that a long term average of the rate at which said samples are stored in said buffer is equal to a long term average of a rate at which said samples are obtained by said codec from said buffer.

16. The invention as defined in claim 15 wherein said samples are obtained by said codec from said buffer under control of a clock, said clock being adjusted as a function of a fullness of said buffer.

17. The invention as defined in claim 15 further comprising:
a phase lock loop receiving as an input an indication of a fullness of said buffer;
wherein said samples are obtained by said codec from said buffer under control of a clock, at least one of a phase and a frequency of said clock being under control of an output signal supplied by said phase locked loop as a function of said indication of buffer fullness.

18. The invention as defined in claim 15 further comprising:
a phase lock loop receiving as an input an indication of a fullness of said buffer and supplying as an output a clock adjust signal that is a function of said buffer fullness indication; and
a clock adjust circuit, said clock adjust circuit receiving as an input a free running clock and supplying as an output an adjusted version of said free running clock in response to said clock adjust signal received from said phase locked loop;
wherein said samples are obtained by said codec from said buffer under control of said adjusted version of said free running clock.

19. The invention as defined in claim 18 wherein at least one of a phase and a frequency of said free running clock is adjusted by said clock adjust circuit.

20. The invention as defined in claim 18 wherein said clock adjust circuit is a digital clock adjust circuit.

21. The invention as defined in claim 18 wherein said clock adjust circuit is voltage controlled.

22. A gateway for coupling a circuit switched connection carrying data as modem signals using a voice band representation and a packet carrying network across which sample timing is not transmitted to said gateway, comprising:
means for storing samples of said voice band representation received from said packet carrying network;
means for converting samples supplied from said buffer to an analog representation;
wherein said samples are obtained by said means for converting from said means for storing at a rate such that a long term average of the rate at which said samples are received from said network and stored in said means for storing is equal to a long term average of a rate at which said samples are obtained by said means for converting from said means for storing.

23. A method for use in a gateway coupling a circuit switched connection carrying data in a voice band representation to a packet carrying network across which sample timing is not transmitted, the method comprising the steps of:
storing in a buffer samples of said voice band representation received from said packet carrying network at a first rate;
converting said samples stored in said buffer to an analog representation at a second rate; and
adjusting said second rate so that it has the same long term average rate as does said first rate.

24. The invention as defined in claim 23 wherein said adjusting step is performed by modifying a free running clock to form a modified clock that it has the same long term average rate as does said first rate, said modifying being response to a measure of fullness of said buffer.

25. The invention as defined in claim 23 wherein said adjusting step is performed from time to time.

26. The invention as defined in claim 23 wherein said adjusting step is performed continually.

27. The invention as defined in claim 23 wherein each of said first and second rates are variable over time.

28. A method for use in a gateway coupling a circuit switched connection carrying data in a voice band representation and a packet carrying network across which sample timing is not transmitted to said gateway, the method comprising the steps of:
storing in a buffer samples of said voice band representation received from said packet carrying network at a first rate;
converting said stored samples that are supplied from said buffer to an analog representation at a second rate controlled by a clock of said gateway;
adjusting said clock as a function of an indication of a fullness of said buffer so that said first and second rates have the same long term average.

29. A method for use in a gateway coupling a circuit switched connection carrying data in a voice band representation and a packet carrying network across which sample timing is not transmitted to said gateway, the method comprising the steps of:
storing samples of said voice band representation received from said packet carrying network in a buffer as they arrive at said gateway;
obtaining samples from said buffer by a codec for conversion to an analog representation once said buffer becomes half full until a first prescribed point in time after said buffer became half full, said obtaining being performed at a rate of a first clock;
determining, a buffer fullness level at said first prescribed point in time; and
when said buffer fullness level at said first prescribed point in time is at least at a prescribed amount greater than half full, switching from said first clock to a second clock, said second clock being an adjusted version of said first clock and having a long term average rate equal to the long term average rate at which samples received from said packet carrying network are stored in said buffer.

30. The invention as defined in claim 29 further comprising the step of monitoring said buffer fullness level, and wherein said adjusted clock is developed as a function of a deviation of said buffer fullness from said half full level.

31. The invention as defined in claim 29 further comprising the step of:
when said buffer fullness level at said first prescribed period of time after said buffer became half full is at least at a prescribed amount less than half full, continuing to obtain samples from said buffer by said codec for conversion to an analog representation at said rate of said first clock;
determining, a buffer fullness level at a second prescribed point in time, which is later than said first prescribed point; and
when said buffer fullness level at said second point in time is at least a prescribed amount less than it was at said first point in time, switching from said first clock to a second clock, said second clock being an adjusted version of said first clock and having a long term average rate equal to the long term average rate at which samples received from said packet carrying network are stored in said buffer.

32. The invention as defined in claim 29 further comprising the step of:
when said buffer fullness level at said first prescribed point in time after said buffer became half full is at least at a prescribed amount less than half full, continuing to obtain samples from said buffer by said codec for conversion to an analog representation at said rate of said first clock;
determining, a buffer fullness level at a second prescribed point in time, which is later than said first prescribed point; and
when said buffer fullness level at said second point in time is not less than it was at said first point in time, said codec continues to use said first clock to obtaining samples from said buffer.

33. A method for use in a gateway coupling a circuit switched connection carrying data in a voice band representation to a packet carrying network across which sample timing is not transmitted, the method comprising the steps of:
storing samples of said voice band representation received from said packet carrying network in a buffer as they arrive, said samples being stored in said buffer;
obtaining samples from said buffer by a codec for conversion to an analog representation once said buffer becomes half full until a first prescribed point in time after said buffer became half full, said obtaining being performed at a rate of a first clock;
determining, a buffer fullness level at said first prescribed point in time; and
when said buffer fullness level at said first prescribed point in time is at least at a prescribed amount greater than half full, beginning a process of adjusting said first clock to develop an adjusted clock that has a long term average rate equal to the long term average rate at which samples received from said packet carrying network are stored in said buffer, and employing said adjusted clock to obtain samples from said buffer by said codec.

34. A method for use in a voice over internet protocol (VoIP) gateway, said VoIP gateway employing a buffer for temporarily storing received voice band samples which represent data signals and were generated by a modem, said VoIP gateway also including a clock that indicates when a sample should be extracted from said buffer for eventual conversion back to an analog signal, the method comprising the steps of:
monitoring a fullness level of said buffer; and
adjusting a frequency of said clock so that a long term average of the rate at which said received voice band samples are supplied to said buffer is equal to a long term average of said frequency of said clock.

35. A method for use in a communications arrangement including a plurality of gateways, each of said gateways being capable of coupling a circuit switched connection carrying data signals converted by a modem to a voice band representation with a packet carrying network, the method being for use in at least one of said gateways to which sample timing is not transmitted from said network, said at least one gateway being adapted to (i) store in a buffer samples of said voice band representation received from said packet carrying network at a first rate; (ii) convert said samples stored in said buffer to an analog representation at a second rate; and (iii) adjust, under controllable command, said second rate, said method comprising the steps of:
making a determination as a function of at least one measure of fullness of said buffer that it is appropriate to adjust said second rate; and
issuing, in response to said determination, a command to adjust said second rate so that it has the same long term average as does said first rate.

36. The invention as defined in claim 35 wherein said making step comprises the steps of:
upon initially establishing a connection between said at least one gateway and said network, storing said samples in said buffer and setting said second rate to zero;
upon reaching a level of prescribed fullness, setting said second rate to the rate of a free running clock;
determining a level of said buffer fullness at a first time point after reaching said prescribed level of buffer fullness; and
when said buffer fullness at said first time point has deviated in a prescribed manner from said prescribed level, determining that it is appropriate to adjust said second rate.

37. The invention as defined in claim 36 wherein said prescribed level is half full.

38. The invention as defined in claim 36 wherein said prescribed manner is that said buffer has filled beyond said prescribed level.

39. The invention as defined in claim 36 wherein said prescribed manner is that said buffer has emptied to a level lower than said prescribed level.

40. The invention as defined in claim 36 wherein said prescribed manner is of the same nature but greater magnitude as a deviation from said prescribed level that was found at a second point earlier in time than said first point.
